(19) United States
(12) Patent Application Publication
(10) Pub. No.: US 2017/0219192 A1
(43) Pub. Date: Aug. 3, 2017

(54) LIGHT-EMITTING ASSEMBLY AND METHOD FOR MANUFACTURING THE SAME

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Haifei Su, Beijing (CN); Shuai Xu, Beijing (CN)

(21) Appl. No.: 15/228,630

(22) Filed: Aug. 4, 2016

(30) Foreign Application Priority Data
Feb. 1, 2016 (CN) 201610070385.8

(51) Int. Cl. F21V 21/14; F21V 17/10; F21V 23/00; F21V 17/08

(52) U.S. Cl. CPC F21V 21/14; F21V 17/08; F21V 17/101; F21V 23/003; F21Y 2115/10

(57) ABSTRACT

Disclosed is light-emitting assembly comprising an elastic plate comprising: an elastic base and a plurality of connecting parts protrusively provided on the elastic plate, the plurality of connecting parts being spaced apart from each other; and a flexible light-emitting plate secured on a side of the connecting parts facing away from the elastic base, wherein portions of the flexible light-emitting plate located between adjacent connecting parts are arched toward a direction away from the elastic plate to form an arched portion when the elastic plate is in an un-deformed state, and the arched portions of the flexible light-emitting plate are flattened when the elastic plate is deformed by stretching. A method for manufacturing a light-emitting assembly is also disclosed. The light-emitting assembly is applicable to occasions in which the elastic deformation of the light-emitting assembly is required.

### CROSS-REFERENCE TO RELATED APPLICATION

This application claims the benefit of Chinese Patent Application No. CN201610070385.8 filed on Feb. 1, 2016 in the State Intellectual Property Office of China, the whole disclosure of which is incorporated herein by reference.

### BACKGROUND OF THE INVENTION

Field of the Invention

Embodiments of the present invention relate to field of light-emitting equipment, in particular to a light-emitting assembly and a method for manufacturing the same.

Description of the Related Art

A light-emitting diode has been widely used as a light-emitting element having low energy consumption and high luminance. For example, it may be used in a display panel.

With the improvement of living standard, the existing light-emitting assembly cannot satisfy demands of people.

### SUMMARY OF THE INVENTION

The present invention is intended to provide a light-emitting assembly which is elastically deformable so as to be adapted to many different occasions.

In one aspect of embodiments of the present invention, there is provided a light-emitting assembly comprising: an elastic plate comprising an elastic base and a plurality of connecting parts protrusively provided on the elastic base, the plurality of connecting parts being spaced apart from each other; and a flexible light-emitting plate secured on a side of the connecting parts facing away from the elastic base, wherein portions of the flexible light-emitting plate located between adjacent connecting parts are arched toward a direction facing away from the elastic plate to form an arched portion when the elastic plate is in an un-deformed state; and wherein the arched portions of the flexible light-emitting plate are extendable to be flattened when the elastic plate is deformed by stretching.

According to an exemplary embodiment of the present invention, the elastic plate comprises an adhesive layer formed on a surface of each of the connecting parts facing away from the elastic base, and the flexible light-emitting plate is adhered onto each of the connecting parts through the adhesive layer.

According to an exemplary embodiment of the present invention, the flexible light-emitting plate is connected with the connecting parts by a snap-fit piece.

According to an exemplary embodiment of the present invention, the snap-fit piece comprises a protrusion formed on one of the flexible light emitting plate and the connecting part and an engaging slot formed on the other of the flexible light emitting plate and the connecting part.

According to an exemplary embodiment of the present invention, the elastic base is integrally formed with the connecting part and made of the same material as that of the connecting part.

According to an exemplary embodiment of the present invention, the elastic plate is made of VHB foam.

According to an exemplary embodiment of the present invention, the elastic base has a rectangular parallelopiped shape, a projection of each connecting part onto the elastic base has a rectangular shape, and an extending direction of the connecting parts is parallel with an edge of the elastic base.

According to an exemplary embodiment of the present invention, each edge of the flexible light-emitting plate is aligned with a corresponding edge of the elastic base.

According to an exemplary embodiment of the present invention, the flexible light-emitting plate comprises a flexible base and a light-emitting diode formed on the flexible base.

According to an exemplary embodiment of the present invention, the light-emitting assembly further comprises a drive circuit for driving the light-emitting diode to emit light.

In another aspect of embodiments of the present invention, there is provided a method for manufacturing the light-emitting assembly as described above, the method comprising: providing the elastic plate comprising the elastic base and the plurality of connecting parts protrusively provided on the elastic plate; applying a pulling force to the elastic plate so that the elastic plate is in a stretched state; providing the flexible light-emitting plate on the elastic plate in the stretched state and securing light-emitting plate onto the connecting parts; and removing the pulling force applied on the elastic plate.

According to an exemplary embodiment of the present invention, the step of providing the elastic plate comprises: providing a VHB foam tape; and etching the VHB foam tape and forming recesses in the VHB foam tape so that portions of the VHB foam tape at either side of the recesses are formed as the connecting parts and a portion of the VHB foam below the connecting parts is formed as the elastic base.

According to an exemplary embodiment of the present invention, the step of etching the VHB foam tape is performed by a laser engraving process.

In the light-emitting assembly according to the embodiments of the present invention, due to an elasticity of the elastic base of the elastic plate and a flexibility of the flexible light-emitting plate, the elastic base can be stretched to be elastically deformed. In this case, the arched portions of the flexible light-emitting plate disposed on the connecting parts will be flattened without being damaged. On the other hand, when the pulling force applied to the flexible base is withdrawn, the elastic base restores to its original state, and the flexible light-emitting plate also restores to a state in which the portions thereof located between the two adjacent connecting parts are arched toward a direction away from the elastic plate without being damaged.

That is to say, no matter whether the elastic base is in an elastic deformation state or not, the flexible light-emitting plate can emit light normally, so that the light-emitting assembly of the present application may be applicable to occasions in which the elastic deformation of the light-emitting assembly is required.

### BRIEF DESCRIPTION OF THE DRAWINGS

The accompanying drawings herein can provide further understanding to embodiments of the present invention and form a part of the embodiments of the present invention. Illustrative embodiments of the present embodiments and their description are intended to explain the present embodiments, rather than being construed as being limited thereto, in which:

FIG. 1 is a schematic view of a light-emitting assembly according to an exemplary embodiment of the present invention; and

FIG. 2 is a flow chart of a method for manufacturing a light-emitting assembly according to an exemplary embodiment of the present invention.

### REFERENCE LIST

100: flexible light-emitting plate
200: elastic plate
210: elastic base
220: connecting parts

### DETAILED DESCRIPTION OF PREFERRED EMBODIMENTS OF THE INVENTION

Embodiments of the present invention will be described hereinafter in detail with reference the accompanying drawings. It should be noted that the embodiments described herein are intended to only explain and illustrate the present embodiments, rather than being construed as being limited thereto.

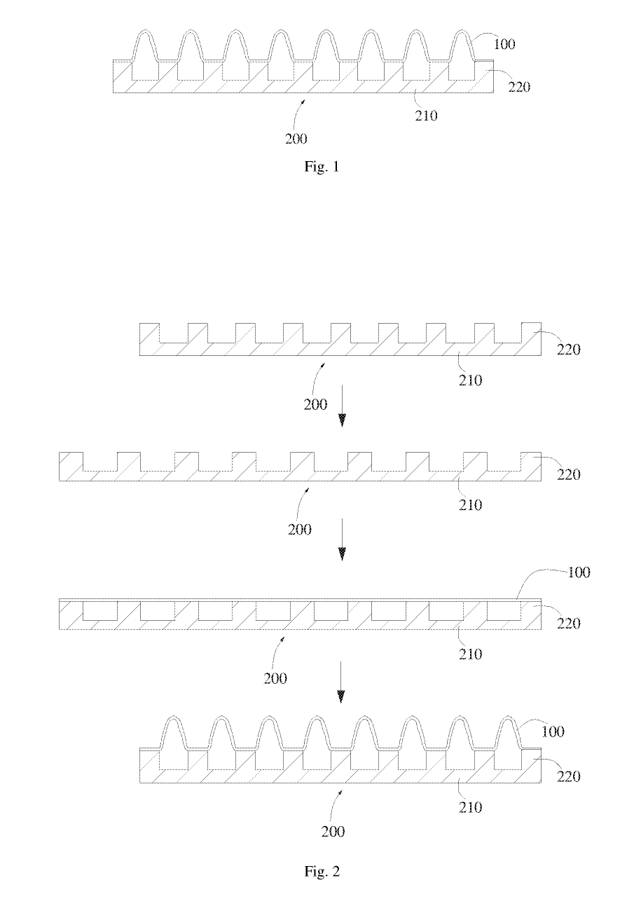

FIG. 1 is a schematic view of a light-emitting assembly according to an exemplary embodiment of the present invention. As shown in FIG. 1, the light-emitting assembly comprises a flexible light-emitting plate 100 and an elastic plate 200. The elastic plate 200 comprises an elastic base 210 and a plurality of connecting parts 220 protruding from the elastic base 210 and spaced apart from each other. The flexible light-emitting plate 100 is secured on a side of the connecting parts 220 facing away from the elastic base 100. When the elastic plate 200 is in an un-deformed state, portions of the flexible light-emitting plate 100 located between two adjacent connecting parts 220 are arched toward a direction away from the elastic plate 200 to form arched portions.

In the light-emitting assembly according to the embodiment of the present invention, due to an elasticity of the elastic base 210 of the elastic plate 200 and a flexibility of the flexible light-emitting plate 100, the elastic base 210 may be stretched elastically. In this case, the arched portions of the flexible light-emitting plate 100 disposed on the connecting parts 220 will be flattened without being damaged. When a pulling force applied to the flexible base 210 is withdrawn, the elastic base 210 restores to its original state, and the flexible light-emitting plate 100 also restores to a state in which portions thereof located between adjacent connecting parts 220 are arched toward a direction away from the elastic plate 200 without being damaged. That is to say, no matter whether the elastic base 210 is in an elastic deformation state or not, the flexible light-emitting plate 100 can emit light normally, so that the light-emitting assembly may be applicable to occasions in which the elastic deformation of the light-emitting assembly is required. For example, the light-emitting assembly may be applied to electronic devices requiring the deformation of the light-emitting assembly, such as a curved display device, a wearable display device and the like.

In the embodiment of the present invention, there is no limitation on how to secure the flexible light-emitting plate 100 onto the connecting parts 200. For example, the flexible light-emitting plate 100 may be secured onto the connecting parts 200 by a snap-fit piece. Specifically, a plurality of protrusions may be provided on a back surface of the flexible light-emitting plate 100, and an engaging slot may be provided in each of the connecting parts 220. The protrusions on the back surface of the flexible light-emitting plate 100 are elastically deformable. When they are not elastically deformed, a volume of each of the protrusions is larger than that of the respective engaging slot. The flexible light-emitting plate 100 can be fixedly connected to the connecting parts 220 by making the protrusions elastically deformed (i.e., compressed) so as to be placed into the engaging slots respectively. Alternatively, the engaging slots may be provided in the back surface of the flexible light-emitting plate 100, and the protrusions may be provided on the connecting parts 220.

In order to facilitate manufacturing and reduce cost, according to an exemplary embodiment of the present invention, the elastic plate 200 may comprise an adhesive layer formed on a surface of each of the connecting parts 220 facing away from the elastic base 210. The flexible light-emitting plate 100 is adhered onto the connecting parts 220 by the adhesive layer.

In an exemplary embodiment of the present invention, the elastic base 210 is integrally formed with the connecting parts 220 and the elastic base 210 is made of the same material as that of the connecting parts 220.

The elastic plate may be formed by firstly providing a base material and then etching recesses in the base material.

In an exemplary embodiment of the present invention, the elastic plate 200 is made of VHB foam. In other words, the elastic plate 200 may be made of VHB foam tape. Various VHB foam tapes may be available from the market, and the description thereof will be omitted herein.

In an exemplary embodiment of the present invention, the elastic base 210 may has a rectangular parallelopiped shape. In order to facilitate manufacturing, in an exemplary embodiment of the present invention, a projection of each connecting part 220 onto the elastic base 210 has a rectangular shape, and an extending direction of the connecting parts 220 is parallel to an edge of the elastic base 210. In other words, edges of each of the connecting parts 220 are straight. It is possible to form the elastic plate 200 including the connecting parts 220 and the elastic base 210 by means of cutting the VHB foam tape. A method for manufacturing the elastic plate 200 using the VHB foam tape will be described below, and the description in detail is omitted herein.

According to an exemplary embodiment of the present invention, each edge of the flexible light-emitting plate 100 is aligned with a corresponding edge of the elastic base 210.

In the embodiments of the present invention, the specific structure of the flexible light-emitting plate 100 is not limited herein. As an example, the flexible light-emitting plate 100 may comprise a flexible base and a light-emitting diode formed on the flexible base. Further, the light-emitting assembly may further comprise a drive circuit for driving the light-emitting diode to emit light.

The light-emitting assembly according to the embodiments of the present invention may be used as a display panel for displaying image. It may also be used as a backlight source for providing a light source for a flexible liquid crystal display panel.

A method for manufacturing a light-emitting assembly according to an exemplary embodiment of the present invention will be described below with reference FIG. 2.

As shown in FIG. 2, the method for manufacturing the light-emitting assembly comprises steps of:

providing an elastic plate 200 comprising an elastic base 210 and a plurality of connecting parts 220 protrusively provided on the elastic base 210;

applying a pulling force on the elastic plate 200 so that the elastic plate 200 is in a stretched state;

providing a flexible light-emitting plate 100 on the elastic plate 200 in the stretched state and securing light-emitting plate 100 onto the connecting parts 220; and

withdrawing the pulling force applied on the elastic plate 200.

As shown in FIG. 2D, after withdrawing the pulling force applied on the elastic plate 200, the portions of the flexible light-emitting plate 100 located between connecting parts 220 are arched toward a direction facing away from the elastic base 210 so as to form the light-emitting assembly as shown in FIG. 1.

As described above, the elastic plate 200 may be made of VHB foam tape. Specifically, providing an elastic plate 200 may comprise:

providing a VHB foam tape; and

etching the VHB foam tape and forming recesses in the VHB foam tape, wherein portions at either side of the recesses are formed as the connecting parts and a portion below the connecting parts is formed as the elastic base.

After removing materials of the recess portions, a top surface of each of the formed connecting parts 220 still has an adhesive layer such that the flexible light-emitting plate 100 can be adhered onto the connecting parts 220.

In order to facilitate precisely controlling a size of each connecting parts and a distance between the connecting parts, according to an exemplary embodiment of the present invention, a laser engraving process may be used to etch the VHB foam tape.

As described above, the elastic base 210 may have a rectangular parallelopiped shape. Therefore, the VHB foam tape may also have a rectangular parallelopiped shape. Accordingly, each recess may be a rectangular recess.

It should be understood that the above embodiments are merely exemplary embodiments for illustrating the principle of the present invention, and the present invention is not limited thereto. It would be appreciated by those skilled in the art that various changes or modifications may be made to the embodiments of the present disclosure without departing from the principle and spirit thereof, and these changes or modifications should be fall within the scope of the present invention.

What is claimed is:

1. A light-emitting assembly comprising:
an elastic plate comprising an elastic base and a plurality of connecting parts protrusively provided on the elastic base, the plurality of connecting parts being spaced apart from each other; and
a flexible light-emitting plate secured on a side of the connecting parts facing away from the elastic base,
wherein portions of the flexible light-emitting plate located between adjacent connecting parts are arched toward a direction facing away from the elastic plate to form arched portions when the elastic plate is in an un-deformed state; and
wherein the arched portions of the flexible light-emitting plate are extendable to be flattened when the elastic plate is deformed by stretching.

2. The light-emitting assembly according to claim 1, wherein the elastic plate comprises an adhesive layer formed on a surface of each of the connecting parts facing away from the elastic base, and the flexible light-emitting plate is adhered onto each of the connecting parts through the adhesive layer.

3. The light-emitting assembly according to claim 1, wherein the flexible light-emitting plate is connected with each of the connecting parts by a snap-fit piece.

4. The light-emitting assembly according to claim 3, wherein the snap-fit piece comprises a protrusion formed on one of the flexible plate and the connecting part and an engaging slot formed on the other of the flexible plate and the connecting part.

5. The light-emitting assembly according to claim 1, wherein the elastic base is integrally formed with the connecting parts and made of the same material as that of the connecting parts.

6. The light-emitting assembly according to claim 2, wherein the elastic base is integrally formed with the connecting parts and made of the same material as that of the connecting parts.

7. The light-emitting assembly according to claim 3, wherein the elastic base is integrally formed with the connecting parts and made of the same material as that of the connecting parts.

8. The light-emitting assembly according to claim 5, wherein the elastic plate is made of VHB foam.

9. The light-emitting assembly according to claim 6, wherein the elastic plate is made of VHB foam.

10. The light-emitting assembly according to claim 1, wherein
the elastic base has a rectangular parallelopiped shape;
a projection of each of the connecting parts onto the elastic base has a rectangular shape; and
an extending direction of each of the connecting parts is parallel with an edge of the elastic base.

11. The light-emitting assembly according to claim 2, wherein
the elastic base has a rectangular parallelopiped shape;
a projection of each of the connecting parts onto the elastic base has a rectangular shape; and
an extending direction of each of the connecting parts is parallel with an edge of the elastic base.

12. The light-emitting assembly according to claim 10, wherein each edge of the flexible light-emitting plate is aligned with a corresponding edge of the elastic base.

13. The light-emitting assembly according to claim 11, wherein each edge of the flexible light-emitting plate is aligned with a corresponding edge of the elastic base.

14. The light-emitting assembly according to claim 1, wherein the flexible light-emitting plate comprises a flexible base and a light-emitting diode formed on the flexible base.

15. The light-emitting assembly according to claim 2, wherein the flexible light-emitting plate comprises a flexible base and a light-emitting diode formed on the flexible base.

16. The light-emitting assembly according to claim 14, wherein the light-emitting assembly further comprises a drive circuit for driving the light-emitting diode to emit light.

17. The light-emitting assembly according to claim 15, wherein the light-emitting assembly further comprises a drive circuit for driving the light-emitting diode to emit light.

18. A method for manufacturing the light-emitting assembly according to claim 1, the method comprising steps of:
providing the elastic plate comprising the elastic base and the plurality of connecting parts protrusively provided on the elastic plate;
applying a pulling force on the elastic plate so that the elastic plate is in a stretched state;
providing the flexible light-emitting plate on the elastic plate in the stretched state and securing the light-emitting plate onto the connecting parts; and
withdrawing the pulling force applied on the elastic plate, so that portions of the flexible light-emitting plate located between adjacent connecting parts are arched toward a direction facing away from the elastic plate.

19. The method according to claim 18, wherein the step of providing the elastic plate comprises:
providing a VHB foam tape; and
etching the VHB foam tape to form recesses in the VHB foam tape, wherein portions of the VHB foam tape at either side of the recesses are formed as the connecting parts and a portion of the VHB foam below the connecting parts is formed as the elastic base.

20. The method according to claim 19, wherein the step of etching the VHB foam tape is performed by a laser engraving process.
